(19) United States
(12) Patent Application Publication
(10) Pub. No.: US 2024/0161735 A1
(43) Pub. Date: May 16, 2024

(54) DETECTING AND CLASSIFYING FILLER WORDS IN AUDIO USING NEURAL NETWORKS

(71) Applicant: Adobe Inc., San Jose, CA (US)

(72) Inventors: Justin SALAMON, San Francisco, CA (US); Juan-Pablo CACERES CHOMALI, San Francisco, CA (US); Ge ZHU, Rochester, NY (US); Nicholas J. BRYAN, Belmont, CA (US)

(73) Assignee: Adobe Inc., San Jose, CA (US)

(21) Appl. No.: 18/055,739

(22) Filed: Nov. 15, 2022

(51) Int. Cl. G10L 15/16; G10L 15/22; G10L 25/78

(52) U.S. Cl. CPC G10L 15/16; G10L 15/22; G10L 25/78

(57) ABSTRACT

Embodiments are disclosed for performing a filler word detection process on input audio by a media editing system using trained neural networks. In particular, in one or more embodiments, the disclosed systems and methods comprise receiving an input including an audio sequence, analyzing the audio sequence to determine filler word candidates, classifying, by a filler word classification model, each filler word candidate of the filler word candidates into one of a set of categories, and generating an output audio sequence, the output audio sequence including an identification of a subset of the filler word candidates in a filler words category of the set of categories as identified filler words.

### BACKGROUND

Filler words, such as “uh” and “um,” are sounds or words people use to signal they are pausing to think. They are common in spontaneous speech and can also be the result of nervousness, stress, or fatigue. Frequent use of filler words in an audio or video recording can be very disruptive to a person's listening or viewing experience, as they interrupt the flow of speech. Finding and removing filler words from audio and video recordings thus is a common task in media editing. To manually remove filler words, audio and video editors typically must review the entire audio or video recording to identify the occurrences of filler words, which can be tedious and time-consuming.

While some existing solutions attempt to address these issues, they have limitations and drawbacks, as they can be time-consuming and resource-intensive, while producing unreliable results.

### SUMMARY

Introduced here are techniques/technologies that allow a media editing system to detect and classify filler words in an audio sequence. The media editing system uses a series of trained neural networks to identify voice activity in the audio sequence, detect where spoken words are spoken in the audio sequence, and classify any voice activity that does not have corresponding detected spoken words as filler words.

In particular, in one or more embodiments, a media editing system can receive an input including an audio sequence. The audio sequence can be part of a media sequence that includes the audio sequence and a video sequence (e.g., a person giving a presentation or speech). The media editing system can analyze the audio sequence to determine filler word candidates using a voice activity detection model and a speech recognition model. The media system can then classify, by a filler word classification model, each filler word candidate of the filler word candidates into one of a set of categories. The media editing system then generates an output audio sequence, the output audio sequence including an identification of a subset of the filler word candidates in a filler words category of the set of categories as being the identified filler words.

Additional features and advantages of exemplary embodiments of the present disclosure will be set forth in the description which follows, and in part will be obvious from the description, or may be learned by the practice of such exemplary embodiments.

### BRIEF DESCRIPTION OF THE DRAWINGS

The detailed description is described with reference to the accompanying drawings in which:

FIG. 1 illustrates a diagram of a process of identifying filler words in an input audio sequence using trained networks in accordance with one or more embodiments;

FIG. 2 illustrates an example filler word candidate detection phase for an input audio sequence in accordance with one or more embodiments;

FIG. 3 illustrates a diagram of a process of identifying filler words in an input audio sequence using trained networks in accordance with one or more embodiments;

FIG. 4 illustrate a user interface displaying a visualization of a modified audio sequence in accordance with one or more embodiments

FIG. 5 illustrates a diagram of a training system for training a machine learning model to identify filler word candidates in accordance with one or more embodiments;

FIG. 6 illustrates a diagram of a training system for training a machine learning model to classify filler word candidates in accordance with one or more embodiments;

FIG. 7 illustrates a schematic diagram of a media editing system in accordance with one or more embodiments;

FIG. 8 illustrates a flowchart of a series of acts in a method of identifying filler words in an input audio sequence using trained networks of a media editing system in accordance with one or more embodiments;

FIG. 9 illustrates a flowchart of a series of acts in a method of identifying filler words in an input audio sequence using trained networks of a media editing system in accordance with one or more embodiments;

FIG. 10 illustrates a schematic diagram of an exemplary environment in which the media editing system can operate in accordance with one or more embodiments; and

FIG. 11 illustrates a block diagram of an exemplary computing device in accordance with one or more embodiments.

### DETAILED DESCRIPTION

One or more embodiments of the present disclosure include a media editing system that uses trained neural networks to detect and classify filler words (e.g., “um,” “uh,” etc.) in an audio sequence. The neural networks include a voice activity detection model trained to detect the locations of voice activity in an audio sequence and a speech recognition model trained to identify and transcribe spoken words identified in the audio sequence that are used to detect and identify filler word candidates. The trained neural networks also include a filler word classification model trained to classify the filler word candidates into one of a plurality of categories. While existing solutions attempt to identify filler words in audio, they have limitations and disadvantages.

Some existing solutions are directed to detecting and removing speech disfluencies from text transcripts produced via automatic speech recognition systems. These solutions involve the automatic speech recognition systems transcribing the filler words, which requires training an ad-hoc automatic speech recognition systems with filler words in its vocabulary. This can be computationally intensive and challenging since automatic speech recognition systems are often trained on spoken text corpora which do not contain any filler words, and thus cannot detect them reliably. Furthermore, adding a new filler word to the vocabulary would require re-training the automatic speech recognition systems model, which can also be a time-consuming and resource-intensive task.

Existing solutions that use neural networks also have their deficiencies. For example, one existing solution trains a convolutional recurrent neural network for filler word segmentation applied directly to audio recordings. This solution uses two speech datasets, Switchboard speech data with transcripts and Automanner. However, a major limitation of the approach is its inability to distinguish filler words such as “uh” or “um” from real part-of-speech, thus returning false-positive detection for actual words that sound similar to or contain filler words, such as “umbrella.”

To address these issues, after receiving an audio sequence as input, the media editing system analyzes the audio sequence. The media editing system can process the audio sequence through two trained neural networks to generate filler word candidates. The trained neural networks can include a voice activity detection model to detect regions of voice activity in the audio sequence, and a speech recognition model to detect spoken words in the audio sequence. The media editing system can then process the filler word candidates to classify each filler word candidate into one of a set of categories, including a filler words category. Once the filler words are identified from the filler word candidates, the media editing system can generate an output audio sequence. The output audio sequence can include an identification, or indication, of the filler words in the audio sequence based on the regions of the audio sequence indicating as being in the filler words category. In other embodiments, the output can be a set of identification markers with timestamps indicating the location of filler words in the audio sequence or a modified audio sequence with some or all of the identified filler words automatically removed.

By using a trained voice activity detection model and a trained speech recognition model to identify filler word candidates, and then a trained filler word classification model to classify the identified filler word candidates as being filler words or other non-filler word sounds, the embodiments described herein provide a significant increase in filler word detection accuracy and speed. For example, by first identifying the location of filler word candidates, based on comparing locations of detected voice activity with locations of detected spoken words, the media editing system described herein reduces the amount of audio data that needs to be processed and classified to identify the filler words.

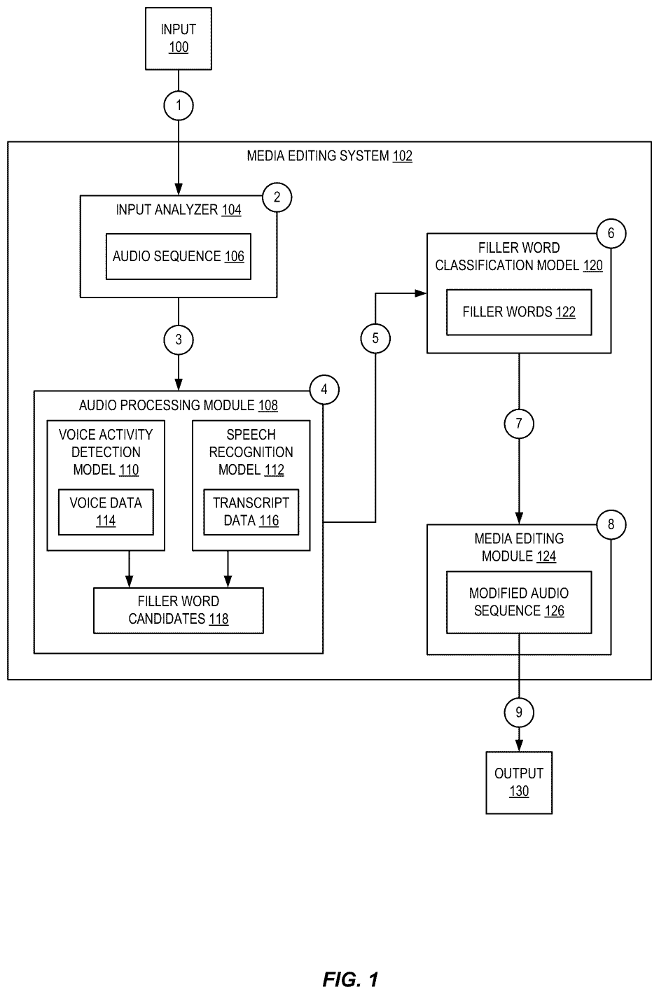

FIG. 1 illustrates a diagram of a process of identifying filler words in an input audio sequence using trained networks in accordance with one or more embodiments. As shown in FIG. 1, a media editing system 102 receives an input 100, as shown at numeral 1. For example, the media editing system 102 receives the input 100 from a user via a computing device or from a memory or storage location. In one or more embodiments, the input 100 includes an audio sequence. The audio sequence can be part of a media sequence that includes both an audio sequence (e.g., audio sequence 106) with a video sequence, or can be an audio sequence without a video sequence.

As illustrated in FIG. 1, the media editing system 102 includes an input analyzer 104 that receives the input 100. In some embodiments, the input analyzer 104 analyzes the input 100, as shown at numeral 2. In some embodiments, the input analyzer 104 analyzes the input 100 to extract the audio sequence 106 from the input 100. After extracting the audio sequence 106 from the input 100, the input analyzer 104 sends the audio sequence 106 to an audio processing module 108, as shown at numeral 3.

In one or more embodiments, the audio processing module 108 processes the audio sequence 106, at numeral 4. In some embodiments, the audio processing module 108 includes a voice activity detection model 110 and a speech recognition model 112 that are used in a filler word candidate detection phase. The voice activity detection model 110 and the speech recognition model 112 can be run serially or in parallel.

The voice activity detection model 110 and the speech recognition model 112 are neural networks. In one or more embodiments, a neural network includes deep learning architecture for learning representations of audio and/or video. A neural network may include a machine-learning model that can be tuned (e.g., trained) based on training input to approximate unknown functions. In particular, a neural network can include a model of interconnected digital neurons that communicate and learn to approximate complex functions and generate outputs based on a plurality of inputs provided to the model. For instance, the neural network includes one or more machine learning algorithms. In other words, a neural network is an algorithm that implements deep learning techniques, i.e., machine learning that utilizes a set of algorithms to attempt to model high-level abstractions in data.

In one or more embodiments, the voice activity detection model 110 is trained to output predictions at a fine temporal resolution (e.g., 100 Hz) that indicate the temporal boundaries of regions of voice activity in the audio sequence 106. In some embodiments, the voice activity detection model 110 outputs a probability sequence (e.g., signal) that indicates a confidence level that the audio sequence 106 is speech or voice activity at each frame. In such embodiments, a median filter can be applied to the signal to smooth the signal, and regions where the probability is above a certain threshold (e.g., 0.5) can be identified. These regions can be marked as [start time, end time]. For example, the voice activity detection model 110 can generate voice data 114 that indicates a start time and end time to the predicted regions of the audio sequence 106 during which the voice activity detection model 110 detected voice activity.

In one or more embodiments, the speech recognition model 112 is a trained model configured to generate transcript data of the audio sequence 106 by recognizing/detecting spoken words within the audio sequence 106 and converting/translating the detected spoken words into text. In one or more embodiments, the speech recognition model 112 is trained using speech corpora of people reading written texts without any non-lexical filler words, such as “uh” and “um.” The written text (e.g., the ground truth data) is then compared with text generated by the speech recognition model 112 to train the speech recognition model 112. As such, the speech recognition model 112 is configured to transcribe spoken words and ignore non-lexical fillers, including “uh” and “um.” When the speech recognition model 112 detects spoken words in the audio sequence 106, the corresponding regions of the output of the speech recognition model 112 will include a transcription of the detected spoken words. When the speech recognition model 112 detects non-lexical fillers in the audio sequence 106, the corresponding regions of the output of the speech recognition model 112 will appear as silent gaps.

After the audio processing module 108 has passed the audio sequence 106 through the voice activity detection model 110 and the speech recognition model 112, the generated the voice data 114 and the transcript data 116 are compared. The regions of the voice data 114 that have corresponding data in the transcript data 116 are discarded as the activation in both the voice data 114 and the transcript data 116 indicate the presence of actual (e.g., non-filler) words. The remaining regions of the voice data 114 are identified as the filler word candidates 118, as these regions have voice activity detected in the voice data 114, but no spoken words detected in the transcript data 116.

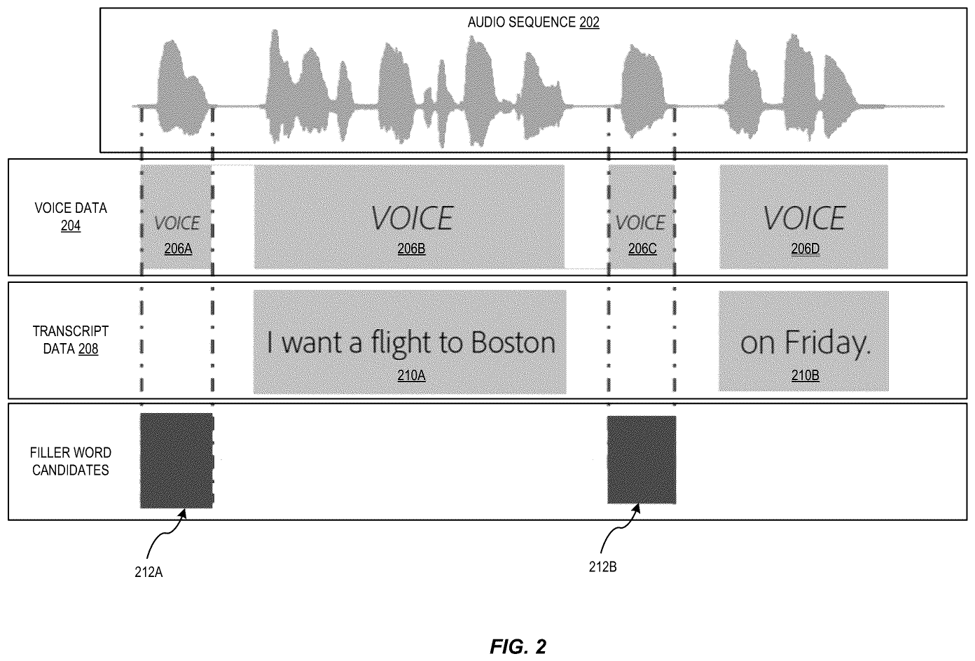

FIG. 2 illustrates an example filler word candidate detection phase for an input audio sequence in accordance with one or more embodiments. As illustrated in FIG. 2, the audio processing module 108 has processed audio sequence 202 through a voice activity detection model (e.g., voice activity detection model 110) and a speech recognition model (e.g., speech recognition model 112). The results of passing the audio sequence 202 through the voice activity detection model include regions 206A-D in voice data 204, during which the voice activity detection model predicted the presence of voice activity. The results of passing the audio sequence 202 through the speech recognition model include transcript region 210A and transcript region 210B, during which the speech recognition model identified and converting the voice/speech in the audio sequence 202 into transcript data 208.

The filler word candidates 212A and 212B are determined by comparing the voice data 204 and the transcript data 208. In one or more embodiments, the portion of audio sequence 202 corresponding to voice region 206B and transcript region 210A can be discarded as a candidate because the transcript data 208 indicates the speech recognition model detected spoken words (e.g., “I want a flight to Boston”). Similarly, the portion of audio sequence 202 coinciding with voice region 206D and transcript region 210B can be discarded because the transcript data 208 indicates the speech recognition model detected spoken words (e.g., “on Friday”). FIG. 2 further shows that the speech recognition model did not detect spoken words in the regions of audio sequence 202 corresponding with voice regions 206A and 206C, indicating those voice regions are filler word candidates 212A and 212B, respectively.

While the example in FIG. 2 shows no data in the transcript data 208 corresponding to the filler word candidates, in other embodiments, filler words and/or unintelligible words can also be displayed in the transcript data 208. In such embodiments, these filler words and/or unintelligible words can also be flagged as filler word candidates.

Returning to FIG. 1, after the audio processing module 108 identifies the filler word candidates 118, the filler word candidates 118 can be sent to a filler word classification model 120, as shown at numeral 5. The filler word classification model 120 is a neural network. In one or more embodiments, a neural network includes deep learning architecture for learning representations of audio and/or video. A neural network may include a machine-learning model that can be tuned (e.g., trained) based on training input to approximate unknown functions. In particular, a neural network can include a model of interconnected digital neurons that communicate and learn to approximate complex functions and generate outputs based on a plurality of inputs provided to the model. For instance, the neural network includes one or more machine learning algorithms. In other words, a neural network is an algorithm that implements deep learning techniques, i.e., machine learning that utilizes a set of algorithms to attempt to model high-level abstractions in data.

The filler word classification model 120 can be considered a keyword-spotting (KWS) task where the keyword is the joint set of filler words “uh” and “um.” In one or more embodiments, for efficient classification, the filler word classification model 120 is an adapted TC-ResNet8, a lightweight KWS model backbone architecture. TC-ResNet8 has around 100 k parameters, making it low latency for prediction. TC-ResNet8 applies 1D convolution in the temporal axis and spans the entire frequency range in every layer, achieving strong performance even with a small number of layers.

In one or more embodiments, the filler word classification model 120 identifies filler words 122 from the filler word candidates 118, at numeral 6. Each of the filler word candidates 118 are typically short voice sounds (e.g., around one second in length). In one or more embodiments, the filler word classification model 120 includes an event classifier trained to identify the voice data corresponding to filler word candidates 118 as being one of: filler words (e.g., “uh” and “um”), laughter, breaths, words (e.g., regular words and repetitions), and music. As each filler word candidate of the filler word candidates 118 is passed through the filler word classification model 120, the filler word classification model 120 categorizes the filler word candidate into one of the described categories. In one or more other embodiments, filler word candidates 118 that are not filtered into one of the above-noted classifications can be placed in a separate category (e.g., an “other” category).

In one or more embodiments, the filler word classification model 120 outputs labeled events for each filler word candidate, where each labeled event includes a start time, an end time, and a category label (indicating a category for each filler word candidate). An example format of a labeled event can be: “0.2˜0.3 s Filler.” Because the filler word candidates are typically short segments, the event classifier is trained to directly predict the category label for the entire input segment. After passing each filler word candidate through the filler word classification model 120, the candidates placed in the “filler words” category can be sent as filler words 122 to a media editing module 124, as shown at numeral 7.

In one or more embodiments, the media editing module 124 generates a modified audio sequence 126, at numeral 8. In some embodiments, the modified audio sequence 126 can include modifications to audio sequence 106 in which the portions of the audio sequence 106 that include filler words 122 are removed or muted. In some embodiments, where the filler words 122 are removed, the media editing module 124 can generate a crossfade at the point of removal to smooth the transition in the audio sequence, and, where the audio sequence 106 is part of a media sequence that includes a video sequence, smooth the transition in the video sequence. In other embodiments, the media editing module 124 generates a visualization of the audio sequence 106 in which the filler words 122 are highlighted, or otherwise indicated, without any modifications to the audio sequence 106 itself. In such embodiments, the visualization of the audio sequence 106 can include options that allow a user to remove or mute some or all of the filler words 122.

In one or more embodiments, the media editing system 102 provides an output 130, including the modified audio sequence 126, as shown at numeral 9. In one or more embodiments, after the process described above in numerals 1-8 the output 130 is sent to the user or computing device that initiated the media editing process with the media editing system 102, to another computing device associated with the user or another user, or to another system or application. For example, after the process described above in numerals 1-9, the modified audio sequence 126 can be displayed in a user interface of a computing device.

In one or more other embodiments, after the filler word classification model 120 identifies the filler words 122, the fillers words 122 can be provided at the output 130 without any modifications made to the audio sequence 106. In such embodiments, the output can include the identification and corresponding timestamps of the filler words 122.

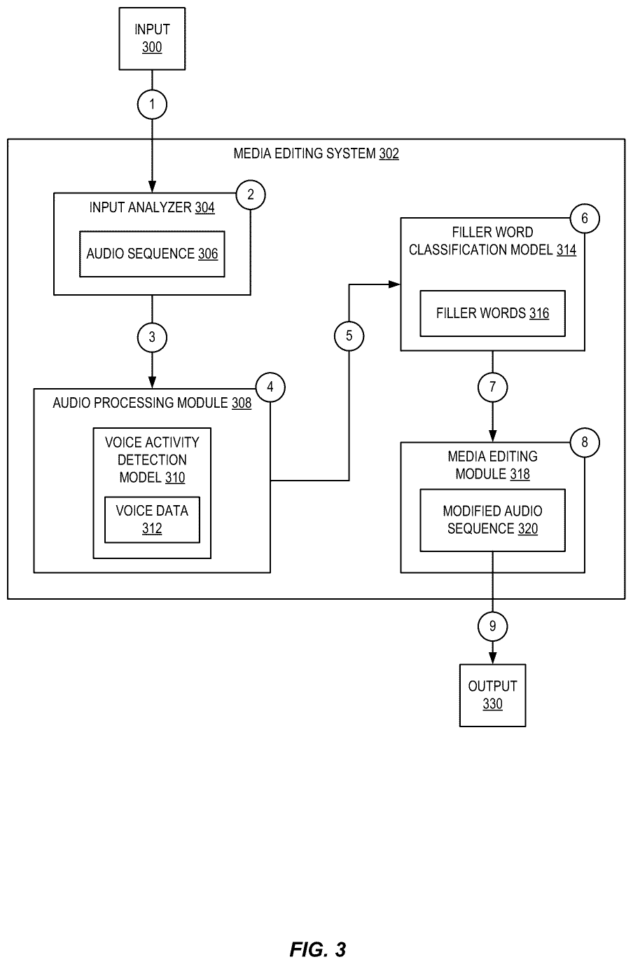

FIG. 3 illustrates a diagram of a process of identifying filler words in an input audio sequence using trained networks in accordance with one or more embodiments. Unlike FIG. 1, the audio processing module 308 in media editing system 302 does not include a speech recognition model. As shown in FIG. 3, a media editing system 302 receives an input 300, as shown at numeral 1. For example, the media editing system 302 receives the input 300 from a user via a computing device or from a memory or storage location. In one or more embodiments, the input 300 includes an audio sequence. The audio sequence can be part of a media sequence that includes both an audio sequence (e.g., audio sequence 306) with a video sequence, or can be an audio sequence without a video sequence.

As illustrated in FIG. 3, the media editing system 302 includes an input analyzer 304 that receives the input 300. In some embodiments, the input analyzer 304 analyzes the input 300, as shown at numeral 2. In some embodiments, the input analyzer 304 analyzes the input 300 to extract the audio sequence 306 from the input 300. After extracting the audio sequence 306 from the input 300, the input analyzer 304 sends the audio sequence 306 to an audio processing module 308, as shown at numeral 3.

In one or more embodiments, the audio processing module 308 processes the audio sequence 306, at numeral 4. In some embodiments, the audio processing module 308 includes a voice activity detection model 310 that is used in a filler word candidate detection phase.

The voice activity detection model 310 is a neural network. In one or more embodiments, a neural network includes deep learning architecture for learning representations of audio and/or video. A neural network may include a machine-learning model that can be tuned (e.g., trained) based on training input to approximate unknown functions. In particular, a neural network can include a model of interconnected digital neurons that communicate and learn to approximate complex functions and generate outputs based on a plurality of inputs provided to the model. For instance, the neural network includes one or more machine learning algorithms. In other words, a neural network is an algorithm that implements deep learning techniques, i.e., machine learning that utilizes a set of algorithms to attempt to model high-level abstractions in data.

In one or more embodiments, the voice activity detection model 310 is trained to output predictions at a fine temporal resolution (e.g., 100 Hz) that indicates the temporal boundaries of regions of voice activity in the audio sequence 306. For example, the voice activity detection model 310 can generate voice data 312 that indicates a start time and end time to the predicted regions of the audio sequence 306 during which the voice activity detection model 310 detects voice activity.

After the audio processing module 308 has passed the audio sequence 306 through the voice activity detection model 310, the generated the voice data 312 can be sent to a filler word classification model 314, as shown at numeral 5. The filler word classification model 314 is a neural network. In one or more embodiments, a neural network includes deep learning architecture for learning representations of audio and/or video. A neural network may include a machine-learning model that can be tuned (e.g., trained) based on training input to approximate unknown functions. In particular, a neural network can include a model of interconnected digital neurons that communicate and learn to approximate complex functions and generate outputs based on a plurality of inputs provided to the model. For instance, the neural network includes one or more machine learning algorithms. In other words, a neural network is an algorithm that implements deep learning techniques, i.e., machine learning that utilizes a set of algorithms to attempt to model high-level abstractions in data.

The filler word classification model 314 can be considered a keyword-spotting (KWS) task where the keyword is the joint set of filler words “uh” and “um.” In one or more embodiments, for efficient classification, the filler word classification model 314 is an adapted TC-ResNet8, a lightweight KWS model backbone architecture. TC-ResNet8 has around 100 k parameters, making it low latency for prediction. TC-ResNet8 applies 1D convolution in the temporal axis and spans the entire frequency range in every layer, achieving strong performance even with a small number of layers.

In one or more embodiments, the filler word classification model 314 identifies filler words 316 from the voice data 312, at numeral 6. In one or more embodiments, the filler word classification model 314 includes a frame-level classifier that receives the voice data 312. The voice data 312 can include sequences of voice of varying lengths. The frame-level classifier is trained to predict frame-level labels at a fine temporal resolution (e.g., ever 100 ms). In one or more embodiments, the frame-level classifier slides across the audio sequence in predetermined time segments. For each time segment, frame-level classifier predicts a probability value of the likelihood of the time segment being associated with one of the categories (e.g., filler words, laughter, breaths, words, and music). The filler word classification model 314 then compares the probability values for the time segments against a threshold value determine how to classify each time segment. After each time segment is classified into one of the categories, the filler word classification model 314 then groups contiguous frames with the same label into an event with a start time and end time.

The final output of the frame-level classifier are discrete events with a start time (e.g., a start timecode in the audio sequence), end time (e.g., an end timecode in the audio sequence), and a category label (indicating a category for each frame). The frame-level classifier identifies frames of the voice data 312 as being one of: filler words (e.g., “uh” and “um”), laughter, breaths, words (e.g., regular words and repetitions), and music. To obtain frame-level predictions, the TC-ResNet8 backbone of the filler word classification model 314 is adapted by adding an LSTM layer. In one or more embodiments, the frame-level predictions are then grouped via post-processing.

After passing the voice data 312 through the filler word classification model 314, the frames placed in the “filler words” category can be sent as filler words 316 to a media editing module 318, as shown at numeral 7.

In one or more embodiments, the media editing module 318 automatically generates a modified audio sequence 320, at numeral 8. In some embodiments, the modified audio sequence 320 can be a modified version of audio sequence 306 in which the filler words 316 are removed or muted. In some embodiments, where the filler words 316 are removed, the media editing module 318 can generate a crossfade at the point of removal to smooth the transition in the audio sequence, and, where the audio sequence 306 is part of a media sequence that includes a video sequence, smooth the transition in the video sequence.

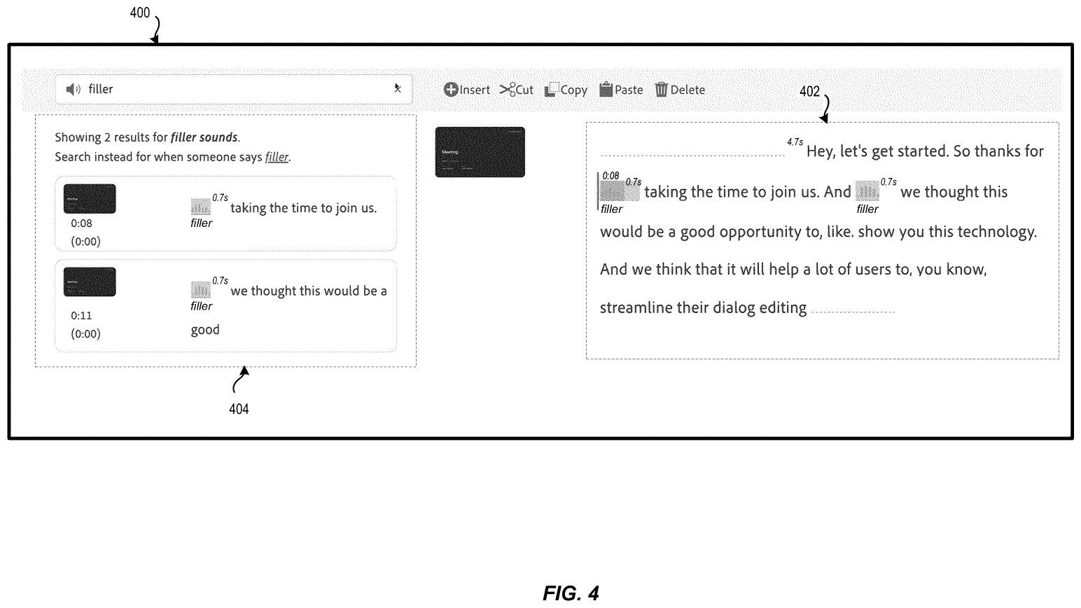

In other embodiments, the media editing module 318 generates a visualization of the modified audio sequence 320 in which the filler words 316 are highlighted, or otherwise indicated that can be presented in a user interface. FIG. 4 illustrate a user interface displaying a visualization of a modified audio sequence in accordance with one or more embodiments. As illustrated in FIG. 4, a user interface 400 displays a visualization 402 of the modified audio sequence. In some embodiments, the visualization 402 of the modified audio sequence can include a transcript of the input audio sequence (e.g., audio sequence 106) and indicators of filler words. For example, the filler words in the transcript can be indicated visually (e.g., highlighted, underlined, etc.). The visualization 402 can also provide users the ability to play each indicated filler word (e.g., to confirm that it contains a filler word) and to delete or mute each indicated filler word. Additional modifications options can include deleting portions of the output audio sequence at the locations of identified filler words, muting the output audio sequence at the locations of the identified filler words, and substituting audio at the locations of the identified filler words.

As illustrated in FIG. 4, the user interface 400 can also include a filler words summary section 404 indicating instance of filler words found in the input audio sequence. The filler words summary section 404 can present some or all of the identified filler words (e.g., based on search criteria), including a timecode associated with the filler word, the duration of the identified filler word, and surrounding dialogue for context.

In response to receiving modifications to the output audio sequence at locations of the identified filler words, the media editing system 302 can generate a modified audio sequence that includes the received modifications applied to the output audio sequence.

Returning to FIG. 3, in one or more embodiments, the media editing system 302 provides an output 330, including the modified audio sequence 320, as shown at numeral 9. In one or more embodiments, after the process described above in numerals 1-8 the output 330 is sent to the user or computing device that initiated the media editing process with the media editing system 302, to another computing device associated with the user or another user, or to another system or application. For example, after the process described above in numerals 1-9, the modified audio sequence 320 can be displayed in a user interface of a computing device.

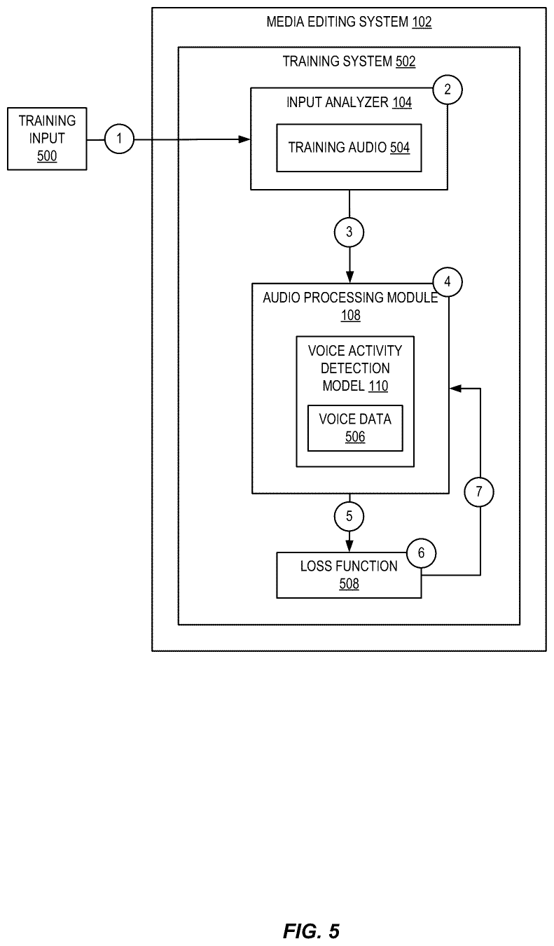

FIG. 5 illustrates a diagram of a training system for training a machine learning model to identify filler word candidates in accordance with one or more embodiments. In one or more embodiments, a training system 502 is configured to train a neural network (e.g., voice activity detection model 110) to predict, or identify, locations of voice activity based on training inputs. Although the training system 502 is depicted as part of media editing system 102, in various embodiments, training system 502 can be a standalone system or a separate system implemented on electronic devices separate from the electronic devices implementing media editing system 102. In such embodiments, the training system 502 can be deployed to the media editing system 102.

As shown in FIG. 5, the training system 502 receives a training input 500, as shown at numeral 1. For example, the media editing system 102 receives the training input 500 from a user via a computing device or from a memory or storage location.

In one or more embodiments, the media editing system 102 includes an input analyzer 104 that receives the training input 500. In some embodiments, the input analyzer 104 analyzes the training input 500, at numeral 2. In some embodiments, the input analyzer 104 analyzes the training input 500 to identify training audio 504. In one or more embodiments, the training audio 504 includes clean speech recordings (e.g., a ground truth data) and a labeled speech dataset created by programmatically combining the clean speech recordings with music and noise using a soundscape mixing software. In one or more embodiments, the training audio 504 is curated to ensure the pitch of the voices in the training audio 504 spans the range of adult speech pitch (e.g., from 60 Hz to 300 Hz), with a mode roughly at the center of the pitch range (e.g., approximately around 170 Hz). In one or more embodiments, the input analyzer 104 sends the training audio 504 to an audio processing module 108, as shown at numeral 3.

In one or more embodiments, the audio processing module 108 processes the training audio 504 using a voice activity detection model 110, at numeral 4. The voice activity detection model 110 is a neural network trained using the training audio 504 to be robust to various background and foreground noises in podcasts such as music and non-speech sounds (e.g., fan noise). In one or more embodiments, the fine temporal resolution is achieved by computing input acoustic features at a 10 ms hop size, such that the trained model can be slid over the audio sequence at this temporal resolution. To ensure robustness, a generalizable ML model is combined with a varied training set containing various background and foreground noises at different signal-to-noise ratios (SNR). In one or more embodiments, the voice activity detection model 110 is a deep neural network (DNN) architecture that is robust in complex environments with noise.

Frame level (e.g., 10 ms) voice activity detection model annotations are generated by computing the audio amplitude from clean speech recordings sourced from the various datasets, labeling regions below a dB threshold relative to the peak amplitude of the normalized signal as silent. The clean speech clips are then programmatically mixed with background music and environmental noise. Using the soundscape mixing software allows for control of the SNR range and distribution in the mixtures. In one or more embodiments, before creating the mixtures, an energy detector is applied to the clean speech. In one embodiment, using a threshold of 19 dB, any regions that are 19 dB lower than the peak amplitude of the training audio 504 are treated as silence. The output of the energy detector is a list of non-silent intervals (e.g., the locations of speech). The signals non-silent intervals are then mixed, or augmented, with “noise” (e.g., actual noise, music, etc.). When the mixtures are generated, the ground truth speech labels and the timestamps for the non-silent intervals are obtained, and the timestamps can be converted into frame-level labels. In one or more embodiments, converting the timestamps to frame-level labels includes quantizing to the resolution of the network. For example, given an input signal that “hops” every 10 ms, each frame is 10 ms long and would be labeled as either speech or non-speech.

In one or more embodiments, the performance of the voice activity detection model 110, in terms of producing filler words candidates, when combined with speech recognition systems can be sensitive to the SNR range. In one embodiment, a speech SNR range of [12, 22] dB relative to background noise, [−3, 17] dB relative to foreground noise and [−6, 14] dB relative to music was selected. In one embodiment, 300,000 mixtures were generated to train the voice activity detection model 110.

Log-scaled mel-spectrograms (log-mel) were computed as input to the voice activity detection model 110. In one embodiment, 64 mel bins and a purposely short window of 25 ms and a hop size of 10 ms were used, to support inference at a high temporal resolution. A convolutional recurrent neural network (CRNN) architecture was adapted by removing the recurrent layer for improved runtime performance.

The resulting voice data 506 generated by the voice activity detection model 110 that indicates the predicted locations of voice activity is then sent to loss function 508, as shown at numeral 5. The resulting voice data 506 generated by the voice activity detection model 110 can then be compared to the clean speech recordings from the training audio 504 (e.g., the ground truth data) to train the voice activity detection model 110 using a binary cross-entropy loss, at numeral 6. The loss calculated using the loss function 508 can then be backpropagated to the voice activity detection model 110, as shown at numeral 7.

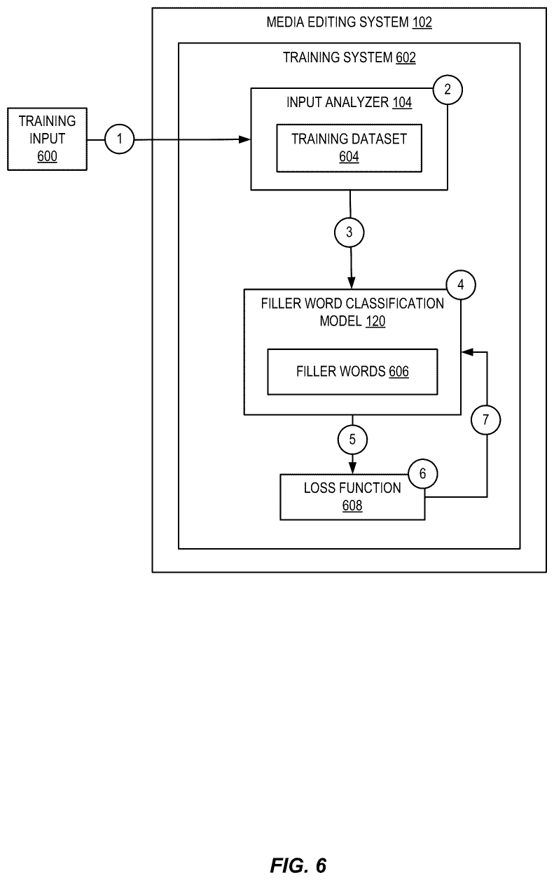

FIG. 6 illustrates a diagram of a training system for training a machine learning model to classify filler word candidates in accordance with one or more embodiments. In one or more embodiments, a training system 602 is configured to train a neural network (e.g., filler word classification model 120) to classify filler word candidates into one of a plurality of categories based on training inputs. Although the training system 602 is depicted as part of media editing system 102, in various embodiments, training system 602 can be a standalone system or a separate system implemented on electronic devices separate from the electronic devices implementing media editing system 102. In such embodiments, the training system 602 can be deployed to the media editing system 102.

As shown in FIG. 6, the training system 602 receives a training input 600, as shown at numeral 1. For example, the media editing system 102 receives the training input 600 from a user via a computing device or from a memory or storage location.

In one or more embodiments, the media editing system 102 includes an input analyzer 104 that receives the training input 600. In some embodiments, the input analyzer 104 analyzes the training input 600, at numeral 2. In some embodiments, the input analyzer 104 analyzes the training input 600 to identify a training dataset 604.

The training dataset 604 can be an annotated dataset of filler words. In one or more embodiments, the annotated dataset of filler words is generated using a voice activity detection model (e.g., voice activity detection model 110) and a speech recognition model (e.g., speech recognition model 112). For example, in one embodiment, using this technique resulted in a training dataset of filler words, based on 145 hours of speech from over 350 speakers coming from 199 public podcast episodes, that includes 35K annotated filler words and 50 K annotations of other speech events that are common in podcasts such as laughter, breaths, and repetitions. The dataset of filler words also includes the speech recognition systems transcriptions produced for the podcast episodes.

As previously noted, automatic speech recognition systems typically do not transcribe non-lexical fillers word (e.g., such as “uh” and “um”) in spontaneous speech. Thus, non-lexical fillers will trigger the voice activity detection model, while appearing as silent gaps in the automatic speech recognition systems output. These regions where voice activity detection model activates but automatic speech recognition systems does not are locations for filler word candidates.

Once trained, as described in FIG. 5, the voice activity detection model was used in combination with the automatic speech recognition systems to produce filler word candidates. In one embodiment, to minimize the chance of missing soft fillers, a lenient voice activity detection model activation threshold of 0.1 (as opposed to the standard 0.5 out of 1) was established. In one or more embodiments, short filler word candidates (e.g., under 150 ms) were removed due to the difficulty in determining whether they were actual filler words or other noises and long candidates (e.g., over 2 s) were removed as they were rare and not representative of target use cases.

In one or more embodiments, the filler word candidates may include other sounds beyond filler words, such as breaths, laughter, music, or even words (due to automatic speech recognition systems errors). To address this, a manual verification process was performed (e.g., via crowdsourcing using a custom annotation interface). In the manual verification process, each filler word candidate was presented to an annotator within a five second clip, for context, where the filler word candidate was positioned at the three second mark and highlighted in the annotation interface. Annotators indicated whether the highlighted filler word candidate was a filler word and depending on this answer, selected one of the five filler category labels or eight non-filler category labels. Each filler candidate was annotated by two annotators, with a third annotator breaking any ties.

In one or more embodiments, wav2vec embeddings are computed with an equivalent 10 ms hop size from the training dataset 604. Wav2vec is an embedding space where times or frequencies are randomly removed (e.g., masked). In one or more embodiments, wav2vec is pretrained on a large dataset of speech, providing a robust representation for classification of speech-like sounds. In one or more embodiments, SpecAugment is applied on the frequency axis and the time axis of the wav2vec embeddings as data augmentation to improve the generalization ability (e.g., to ensure there is balanced training data for different average pitch for different speakers). Augmenting the training dataset 604 can minimize or avoid model overfitting.

In one or more embodiments, the input analyzer 104 sends the training dataset 604 to a filler word classification model 120, as shown at numeral 3. In one or more embodiments, the filler word classification model 120 generates filler words 606 using the training dataset 604, as described with respect to FIGS. 1 and 3, at numeral 4.

In one or more embodiments, to train the filler word classification model 120, the 199 podcasts in the dataset are downsampled from 44.1 kHZ to 16 kHZ to reduce computation cost. The dataset of preprocessed podcasts is then split into train, validation and test sets, keeping a gender-balance. The event classifier and the frame classifier of the filler word classification model 120 are trained on the training dataset 604, hyper-parameters, including VAD threshold and backbones, are tuned on the validation set, and the final performance is compared on the test set. When training the event classifier, a one-second speech segment is used with the filler word candidate in the middle of the segment (ground truth label). The frame classifier is also trained using one-second speech segments but with event based interval labels. In one or more embodiments, the frame classifier aims to produce frame level predictions on the one second speech segments where each frame is 0.1 seconds long.

The filler words 606 generated by the filler word classification model 120 is then sent to loss function 608, as shown at numeral 5. The filler words 606 generated by the filler word classification model 120 can then be compared to the training dataset 604 (e.g., the ground truth data) to train the filler word classification model 120 using a cross-entropy loss, at numeral 6. The loss calculated using the loss function 608 can then be backpropagated to the filler word classification model 120 to train the event classifier and the filler classifier, as shown at numeral 7.

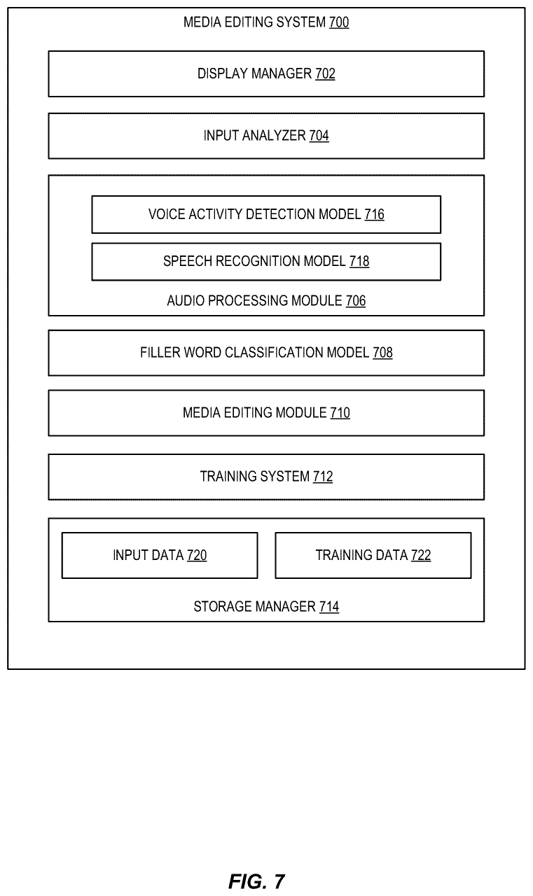

FIG. 7 illustrates a schematic diagram of a media editing system (e.g., “media editing system” described above) in accordance with one or more embodiments. As shown, the media editing system 700 may include, but is not limited to, a display manager 702, an input analyzer 704, an audio processing module 706, a filler word classification model 708, a media editing module 710, a training system 712, and a storage manager 714. As shown, the audio processing module 706 includes a voice activity detection model 716 and a speech recognition model 718. The storage manager 714 includes input data 720 and training data 722.

As illustrated in FIG. 7, the media editing system 700 includes a display manager 702. In one or more embodiments, the display manager 702 identifies, provides, manages, and/or controls a user interface provided on a touch screen or other device. Examples of displays include interactive whiteboards, graphical user interfaces (or simply “user interfaces”) that allow a user to view and interact with content items, or other items capable of display on a touch screen. For example, the display manager 702 may identify, display, update, or otherwise provide various user interfaces that include one or more display elements in various layouts. In one or more embodiments, the display manager 702 can identify a display provided on a touch screen or other types of displays (e.g., including monitors, projectors, headsets, etc.) that may be interacted with using a variety of input devices. For example, a display may include a graphical user interface including one or more display elements capable of being interacted with via one or more touch gestures or other types of user inputs (e.g., using a stylus, a mouse, or other input devices). Display elements include, but are not limited to buttons, text boxes, menus, thumbnails, scroll bars, hyperlinks, etc.

As further illustrated in FIG. 7, the media editing system 700 also includes an input analyzer 704. The input analyzer 704 analyzes an input received by the media editing system 700 to identify an audio sequence. In one or more embodiments, where the input is a media sequence that includes a paired audio sequence and video sequence, the input analyzer 704 is configured to extract the audio sequence from the media sequence.

As further illustrated in FIG. 7, the media editing system 700 also includes audio processing module 706. In one or more embodiments, the audio processing module 706 is configured to analyze and process audio sequences using a voice activity detection model 716 and a speech recognition model 718 to identify candidate filler words in the audio sequences. The voice activity detection model 716 is a neural network trained to output predictions that indicate the temporal boundaries of regions of voice activity in audio sequences. For example, the voice activity detection model 716 can generate voice data that indicates a start time and end time to the predicted regions. The speech recognition model 718 is a neural network trained to generate transcript data of audio sequences by recognizing/detecting spoken words within the audio sequence and converting/translating the detected spoken words into text. The audio processing module 706 compares the outputs of the voice activity detection model 716 and the speech recognition model 718.

As further illustrated in FIG. 7, the media editing system 700 also includes filler word classification model 708 is a neural network trained to identify filler words from the filler word candidates generated by the audio processing module 706. In one or more embodiments, the filler word classification model 708 includes an event classifier trained to identify the filler word candidates as being one of: filler words (e.g., “uh” and “um”), laughter, breaths, words (e.g., regular words and repetitions), and music.

As further illustrated in FIG. 7, the media editing system 700 also includes a media editing module 710 configured to generate a modified audio sequence based on the filler words detected by the filler word classification model 708. In some embodiments, the media editing module 710 can remove the detected filler words and generate a crossfade at the point of removal to smooth the transition in modified the audio sequence, and, where the audio sequence is part of a media sequence that includes a video sequence, smooth the transition in the video sequence. In other embodiments, the media editing module 710 generates a visualization of the modified audio sequence in which the filler words are highlighted, or otherwise indicated. In such embodiments, the visualization of the modified audio sequence can include options that allow a user to remove or mute some or all of the filler words.

As further illustrated in FIG. 7, the media editing system 700 includes training system 712 which is configured to teach, guide, tune, and/or train one or more neural networks. In particular, the training system 712 trains, at least, filler word classification model 708 and voice activity detection model 716, based on training data.

As further illustrated in FIG. 7, the storage manager 714 includes input data 720 and training data 722. In particular, the input data 720 may include an input media sequence (e.g., audio and/or video sequences) received by the media editing system 700. In one or more embodiments, the training data 722 may include audio sequences or media sequences with combined audio and video sequences that can be used during a training process of the media editing system 700 to train the filler word classification model 708 and the voice activity detection model 716.

Each of the components 702-714 of the media editing system 700 and their corresponding elements (as shown in FIG. 7) may be in communication with one another using any suitable communication technologies. It will be recognized that although components 702-714 and their corresponding elements are shown to be separate in FIG. 7, any of components 702-714 and their corresponding elements may be combined into fewer components, such as into a single facility or module, divided into more components, or configured into different components as may serve a particular embodiment.

The components 702-714 and their corresponding elements can comprise software, hardware, or both. For example, the components 702-714 and their corresponding elements can comprise one or more instructions stored on a computer-readable storage medium and executable by processors of one or more computing devices. When executed by the one or more processors, the computer-executable instructions of the media editing system 700 can cause a client device and/or a server device to perform the methods described herein. Alternatively, the components 702-714 and their corresponding elements can comprise hardware, such as a special purpose processing device to perform a certain function or group of functions. Additionally, the components 702-714 and their corresponding elements can comprise a combination of computer-executable instructions and hardware.

Furthermore, the components 702-714 of the media editing system 700 may, for example, be implemented as one or more stand-alone applications, as one or more modules of an application, as one or more plug-ins, as one or more library functions or functions that may be called by other applications, and/or as a cloud-computing model. Thus, the components 702-714 of the media editing system 700 may be implemented as a stand-alone application, such as a desktop or mobile application. Furthermore, the components 702-714 of the media editing system 700 may be implemented as one or more web-based applications hosted on a remote server. Alternatively, or additionally, the components of the media editing system 700 may be implemented in a suit of mobile device applications or “apps.”

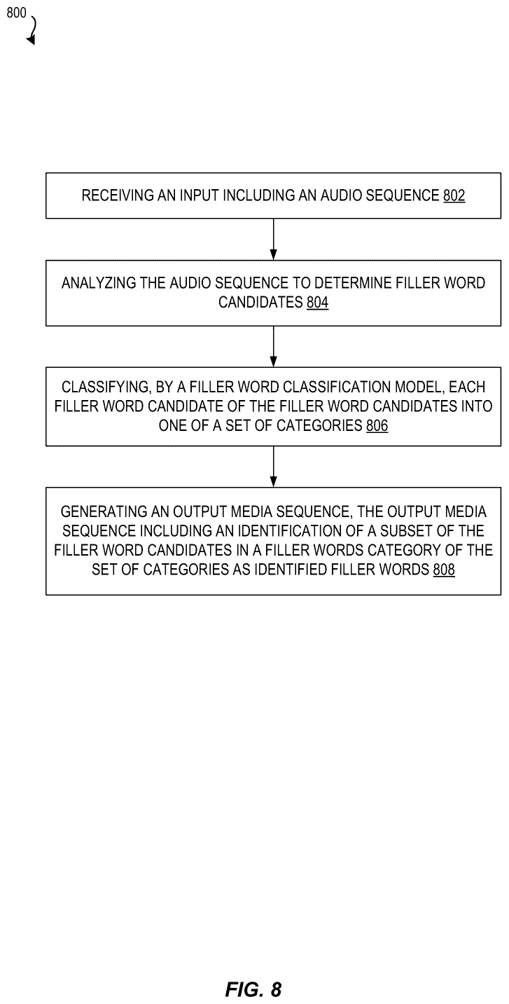

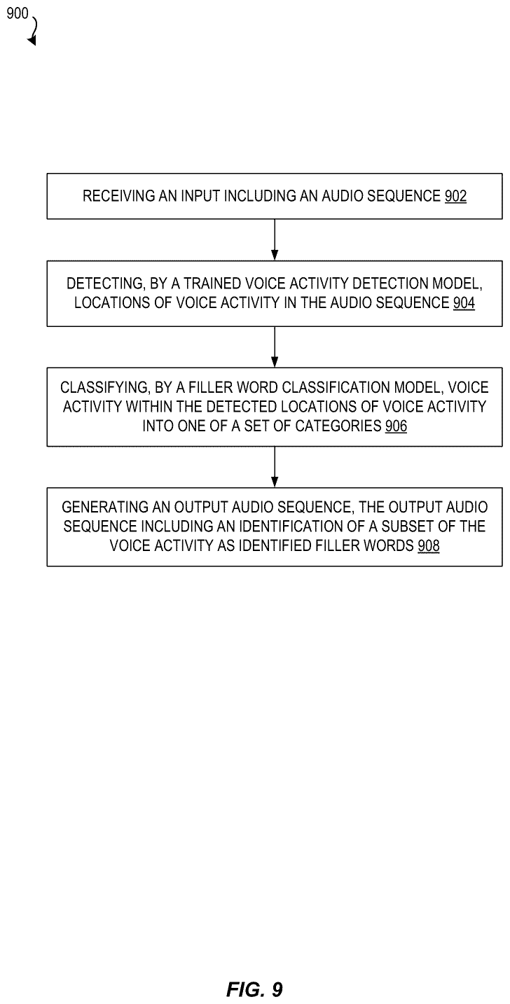

FIGS. 1-7, the corresponding text, and the examples, provide a number of different systems and devices that allow a media editing system to detect and classify filler words in an input audio sequence. In addition to the foregoing, embodiments can also be described in terms of flowcharts comprising acts and steps in a method for accomplishing a particular result. For example, FIGS. 8 and 9 illustrate flowcharts of exemplary methods in accordance with one or more embodiments. The methods described in relation to FIGS. 8 and 9 may be performed with less or more steps/acts or the steps/acts may be performed in differing orders. Additionally, the steps/acts described herein may be repeated or performed in parallel with one another or in parallel with different instances of the same or similar steps/acts.

FIG. 8 illustrates a flowchart of a series of acts in a method of identifying filler words in an input audio sequence using trained networks of a media editing system in accordance with one or more embodiments. In one or more embodiments, the method 800 is performed in a digital medium environment that includes the media editing system 700. The method 800 is intended to be illustrative of one or more methods in accordance with the present disclosure and is not intended to limit potential embodiments. Alternative embodiments can include additional, fewer, or different steps than those articulated in FIG. 8.

As shown in FIG. 8, the method 800 includes an act 802 of receiving an input including an audio sequence. The audio sequence can be part of a request to a media editing system to detect and classify filler words in the audio sequence. In one or more embodiments, the media editing system receives the input from a user (e.g., via a computing device). In one or more embodiments, the user may select the audio sequence in an application, or the user may submit the audio sequence to a web service or an application configured to receive inputs. The audio sequence can also be a portion selected from a longer audio sequence. For example, after providing the audio sequence to the application, the application can provide an interface to enable the user to select a portion of the longer audio sequence. In one or more embodiments, the audio sequence is part of a media sequence that includes the audio sequence and a video sequence (e.g., a video recording of a person giving a speech or presentation).

As shown in FIG. 8, the method 800 also includes an act 804 of analyzing the audio sequence to determine filler word candidates. In some embodiments, the media editing system includes an audio processing module that determines the filler word candidates using a voice activity detection model and a speech recognition model. The voice activity detection model and the speech recognition model are neural networks.

In one or more embodiments, the voice activity detection model is trained to output predictions that indicate the temporal boundaries of regions of voice activity in the audio sequence. For example, the voice activity detection model generates voice data that indicates a start time and end time for each predicted region of the audio sequence during which the voice activity detection model detected voice activity.

In one or more embodiments, the speech recognition model is trained to generate transcript data of the audio sequence by recognizing/detecting spoken words within the audio sequence and converting/translating the detected spoken words into text. The speech recognition model can be trained using speech corpora of people reading written texts without any non-lexical filler words, such as “uh” and “um.” The written text (e.g., the ground truth data) can then be compared with text generated by the speech recognition model to train the speech recognition model to recognize actual words and ignore non-lexical fillers, including “uh” and “um.” When the speech recognition model detects spoken words in the audio sequence, the corresponding regions of the output of the speech recognition model will include a transcription of the detected spoken words. When the speech recognition model detects non-lexical fillers in the audio sequence, the corresponding regions of the output of the speech recognition model will appear as silent gaps (e.g., without any transcript data).

After the audio processing module has passed the audio sequence through the voice activity detection model and the speech recognition model, their outputs can be compared. The regions of the voice data with corresponding data in the transcript data are discarded as the activation in both the voice data and the transcript data indicate the presence of actual (e.g., non-filler) words. The remaining regions of the voice data without corresponding transcript data are identified as the filler word candidates, as these regions have voice activity detected in the voice data, but no spoken words detected by the speech recognition model.

As shown in FIG. 8, the method 800 also includes an act 806 of classifying, by a filler word classification model, each filler word candidate of the filler word candidates into one of a set of categories. In one or more embodiments, the filler word classification model is a neural network.

Each of the filler word candidates are typically short voice sounds (e.g., around one second in length). In one or more embodiments, the filler word classification model includes an event classifier trained to identify the voice data corresponding to filler word candidates as being one of: filler words (e.g., “uh” and “um”), laughter, breaths, words (e.g., regular words and repetitions), and music. As each filler word candidate of the filler word candidates is passed through the filler word classification model, the filler word classification model categorizes the filler word candidate into one of the described categories. In one or more embodiments, there may be fewer, greater, and/or different categories.

In one or more embodiments, the filler word classification model outputs labeled events for each filler word candidate, where each labeled event includes a start time (e.g., a start timecode in the audio sequence), an end time (e.g., an end timecode in the audio sequence), and a label (indicating a category for each filler word candidate). An example format of a labeled event can be: “0.2˜0.3 s Filler.” Because the filler word candidates are typically short segments, the event classifier is trained to directly predict the event label for the entire input segment. After passing each filler word candidate through the filler word classification model, the candidates placed in the “filler words” category can be sent as filler words to a media editing module.

As shown in FIG. 8, the method 800 also includes an act 808 of generating an output audio sequence, the output audio sequence including an identification of a subset of the filler word candidates in a filler words category of the set of categories as identified filler words. In some embodiments, the output audio sequence can be a modified version of the input audio sequence in which the filler words are removed or muted. In some embodiments, where the filler words are removed, the media editing module can generate a crossfade at the point of removal to smooth the transition in the audio sequence, and, where the audio sequence is part of a media sequence that includes a video sequence, also smooth the transition in the video sequence. In other embodiments, the media editing module renders a representation of the output audio sequence in a user interface that includes a visualization of the output audio sequence in which the filler words are highlighted, or otherwise visually indicated, within the context of the audio sequence. In such embodiments, the visualization of the output audio sequence can include options that allow a user to remove or mute some or all of the filler words.

FIG. 9 illustrates a flowchart of a series of acts in a method of identifying filler words in an input audio sequence using trained networks of a media editing system in accordance with one or more embodiments. In the embodiment described in FIG. 9, the audio processing module of the media editing system includes a voice activity detection model but does not include a speech recognition model. In one or more embodiments, the method 900 is performed in a digital medium environment that includes the media editing system 700. The method 900 is intended to be illustrative of one or more methods in accordance with the present disclosure and is not intended to limit potential embodiments. Alternative embodiments can include additional, fewer, or different steps than those articulated in FIG. 9.

As shown in FIG. 9, the method 900 includes an act 902 of receiving an input including an audio sequence. The audio sequence can be part of a request to a media editing system to detect and classify filler words in the audio sequence. In one or more embodiments, the media editing system receives the input from a user (e.g., via a computing device). In one or more embodiments, the user may select the audio sequence in an application, or the user may submit the audio sequence to a web service or an application configured to receive inputs. The audio sequence can also be a portion selected from a longer audio sequence. For example, after providing the audio sequence to the application, the application can provide an interface to enable the user to select a portion of the longer audio sequence. In one or more embodiments, the audio sequence is part of a media sequence that includes the audio sequence and a video sequence (e.g., a video recording of a person giving a speech or presentation).

As shown in FIG. 9, the method 900 also includes an act 904 of detecting, by a trained voice activity detection model, locations of voice activity in the audio sequence. In some embodiments, the media editing system includes an audio processing module that determines the locations of voice activity using a voice activity detection model. The voice activity detection model is a neural network. In one or more embodiments, the voice activity detection model is trained to output predictions that indicate the temporal boundaries of regions of voice activity in the audio sequence. For example, the voice activity detection model generates voice data that indicates a start time (e.g., a start timecode in the audio sequence) and end time (e.g., an end timecode in the audio sequence) for each predicted region of the audio sequence during which the voice activity detection model detected voice activity.

As shown in FIG. 9, the method 900 also includes an act 906 of classifying, by a filler word classification model, voice activity within the detected locations of voice activity into one of a set of categories. In one or more embodiments, the filler word classification model is a neural network.

In one or more embodiments, the filler word classification model identifies filler words from the voice data from the voice activity detection model. In one or more embodiments, the filler word classification model includes a frame-level classifier that receives the voice data. The voice data can include sequences of voice of varying lengths. The frame-level classifier is trained to predict frame-level labels at a fine temporal resolution (e.g., ever 100 ms). In one or more embodiments, the frame-level classifier slides across the audio sequence in predetermined time segments. For each time segment, frame-level classifier predicts a probability value of the likelihood of the time segment including a filler word. The filler word classification model 314 then compares the probability values for the time segments against a threshold value. The filler word classification model 314 identifies the locations of filler words as the time segments having probability values above the threshold value. After each time segment is classified into one of the categories, the filler word classification model 314 then groups contiguous frames with the same label into an event with a start time and end time.

The final output of the frame-level classifier are discrete events with a start time, end time, and a label (indicating a category for each frame). In one or more embodiments, the frame-level classifier identifies frames of the voice data as being one of: filler words (e.g., “uh” and “um”), laughter, breaths, words (e.g., regular words and repetitions), and music. To obtain frame-level predictions, the TC-ResNet8 backbone of the filler word classification model is adapted by adding an LSTM layer. In one or more embodiments, the frame-level predictions are then grouped via post-processing.

As shown in FIG. 9, the method 900 also includes an act 908 of generating an output audio sequence, the output audio sequence including an identification of a subset of the voice activity as identified filler words. In some embodiments, the output audio sequence can be a modified version of the input audio sequence in which the filler words are removed or muted. In some embodiments, where the filler words are removed, the media editing module can generate a crossfade at the point of removal to smooth the transition in the audio sequence, and, where the audio sequence is part of a media sequence that includes a video sequence, also smooth the transition in the video sequence. In other embodiments, the media editing module generates a visualization of the output audio sequence in which the filler words are highlighted, or otherwise indicated. In such embodiments, the visualization of the output audio sequence can include options that allow a user to remove or mute some or all of the filler words.

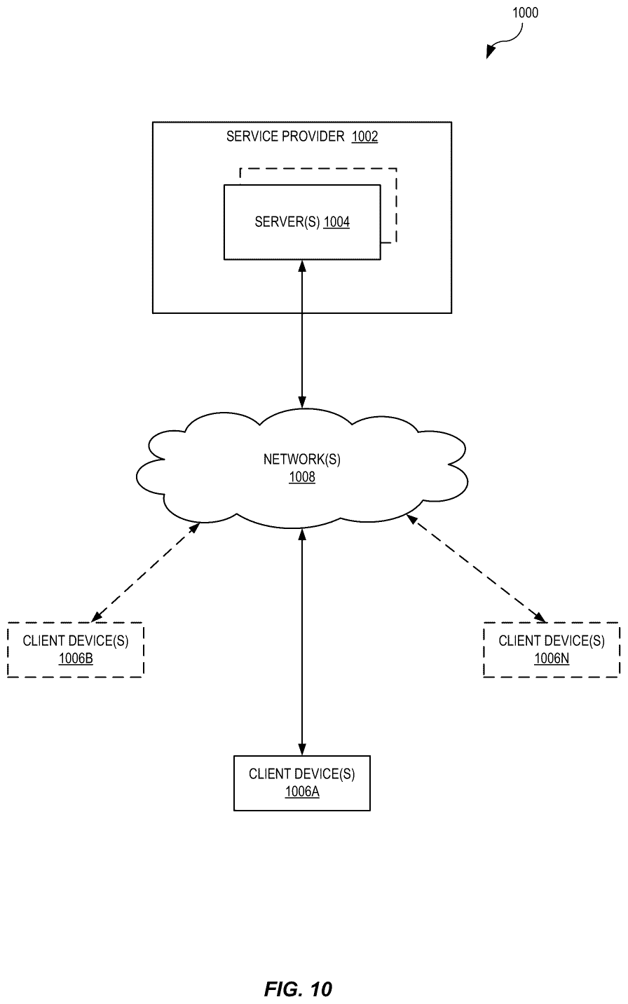

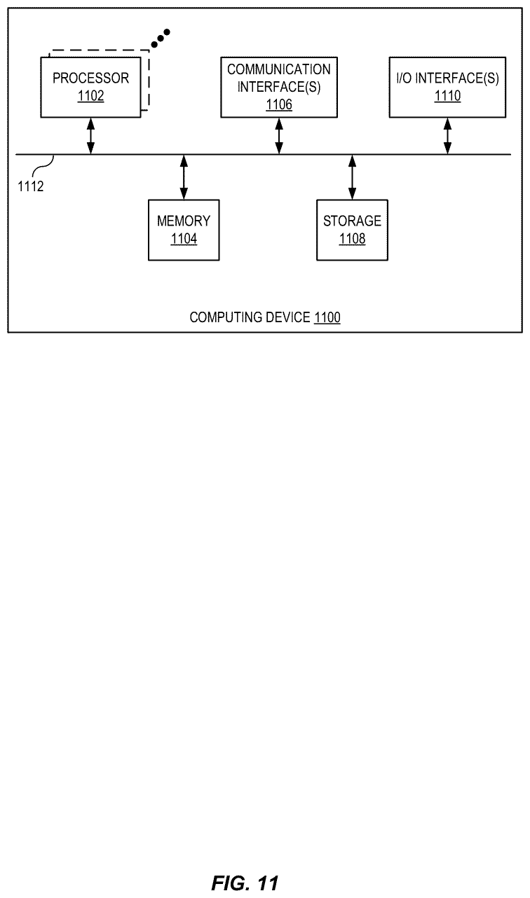

FIG. 10 illustrates a schematic diagram of an exemplary environment 1000 in which the media editing system 700 can operate in accordance with one or more embodiments. In one or more embodiments, the environment 1000 includes a service provider 1002 which may include one or more servers 1004 connected to a plurality of client devices 1006A-1006N via one or more networks 1008. The client devices 1006A-1006N, the one or more networks 1008, the service provider 1002, and the one or more servers 1004 may communicate with each other or other components using any communication platforms and technologies suitable for transporting data and/or communication signals, including any known communication technologies, devices, media, and protocols supportive of remote data communications, examples of which will be described in more detail below with respect to FIG. 11.

Although FIG. 10 illustrates a particular arrangement of the client devices 1006A-1006N, the one or more networks 1008, the service provider 1002, and the one or more servers 1004, various additional arrangements are possible. For example, the client devices 1006A-1006N may directly communicate with the one or more servers 1004, bypassing the network 1008. Or alternatively, the client devices 1006A-1006N may directly communicate with each other. The service provider 1002 may be a public cloud service provider which owns and operates their own infrastructure in one or more data centers and provides this infrastructure to customers and end users on demand to host applications on the one or more servers 1004. The servers may include one or more hardware servers (e.g., hosts), each with its own computing resources (e.g., processors, memory, disk space, networking bandwidth, etc.) which may be securely divided between multiple customers, each of which may host their own applications on the one or more servers 1004. In some embodiments, the service provider may be a private cloud provider which maintains cloud infrastructure for a single organization. The one or more servers 1004 may similarly include one or more hardware servers, each with its own computing resources, which are divided among applications hosted by the one or more servers for use by members of the organization or their customers.

Similarly, although the environment 1000 of FIG. 10 is depicted as having various components, the environment 1000 may have additional or alternative components. For example, the environment 1000 can be implemented on a single computing device with the media editing system 700. In particular, the media editing system 700 may be implemented in whole or in part on the client device 1006A. Alternatively, in some embodiments, the environment 1000 is implemented in a distributed architecture across multiple computing devices.

As illustrated in FIG. 10, the environment 1000 may include client devices 1006A-1006N. The client devices 1006A-1006N may comprise any computing device. For example, client devices 1006A-1006N may comprise one or more personal computers, laptop computers, mobile devices, mobile phones, tablets, special purpose computers, TVs, or other computing devices, including computing devices described below with regard to FIG. 11. Although three client devices are shown in FIG. 10, it will be appreciated that client devices 1006A-1006N may comprise any number of client devices (greater or smaller than shown).

Moreover, as illustrated in FIG. 10, the client devices 1006A-1006N and the one or more servers 1004 may communicate via one or more networks 1008. The one or more networks 1008 may represent a single network or a collection of networks (such as the Internet, a corporate intranet, a virtual private network (VPN), a local area network (LAN), a wireless local network (WLAN), a cellular network, a wide area network (WAN), a metropolitan area network (MAN), or a combination of two or more such networks. Thus, the one or more networks 1008 may be any suitable network over which the client devices 1006A-1006N may access the service provider 1002 and server 1004, or vice versa. The one or more networks 1008 will be discussed in more detail below with regard to FIG. 11.

In addition, the environment 1000 may also include one or more servers 1004. The one or more servers 1004 may generate, store, receive, and transmit any type of data, including input data 720 and training data 722 or other information. For example, a server 1004 may receive data from a client device, such as the client device 1006A, and send the data to another client device, such as the client device 1006B and/or 1006N. The server 1004 can also transmit electronic messages between one or more users of the environment 1000. In one example embodiment, the server 1004 is a data server. The server 1004 can also comprise a communication server or a web-hosting server. Additional details regarding the server 1004 will be discussed below with respect to FIG. 11.

As mentioned, in one or more embodiments, the one or more servers 1004 can include or implement at least a portion of the media editing system 700. In particular, the media editing system 700 can comprise an application running on the one or more servers 1004 or a portion of the media editing system 700 can be downloaded from the one or more servers 1004. For example, the media editing system 700 can include a web hosting application that allows the client devices 1006A-1006N to interact with content hosted at the one or more servers 1004. To illustrate, in one or more embodiments of the environment 1000, one or more client devices 1006A-1006N can access a webpage supported by the one or more servers 1004. In particular, the client device 1006A can run a web application (e.g., a web browser) to allow a user to access, view, and/or interact with a webpage or website hosted at the one or more servers 1004.

Upon the client device 1006A accessing a webpage or other web application hosted at the one or more servers 1004, in one or more embodiments, the one or more servers 1004 can provide a user of the client device 1006A with an interface to provide inputs, including an audio sequence. Upon receiving the audio sequence, the one or more servers 1004 can automatically perform the methods and processes described above to detect and classify filler words in an input audio sequence.

As just described, the media editing system 700 may be implemented in whole, or in part, by the individual elements 1002-1008 of the environment 1000. It will be appreciated that although certain components of the media editing system 700 are described in the previous examples with regard to particular elements of the environment 1000, various alternative implementations are possible. For instance, in one or more embodiments, the media editing system 700 is implemented on any of the client devices 1006A-1006N. Similarly, in one or more embodiments, the media editing system 700 may be implemented on the one or more servers 1004. Moreover, different components and functions of the media editing system 700 may be implemented separately among client devices 1006A-1006N, the one or more servers 1004, and the network 1008.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 11 illustrates, in block diagram form, an exemplary computing device 1100 that may be configured to perform one or more of the processes described above. One will appreciate that one or more computing devices such as the computing device 1100 may implement the media editing system 700. As shown by FIG. 11, the computing device can comprise a processor 1102, memory 1104, one or more communication interfaces 1106, a storage device 1108, and one or more input or output (“I/O”) devices/interfaces 1110. In certain embodiments, the computing device 1100 can include fewer or more components than those shown in FIG. 11. Components of computing device 1100 shown in FIG. 11 will now be described in additional detail.

In particular embodiments, processor(s) 1102 includes hardware for executing instructions, such as those making up a computer program. As an example, and not by way of limitation, to execute instructions, processor(s) 1102 may retrieve (or fetch) the instructions from an internal register, an internal cache, memory 1104, or a storage device 1108 and decode and execute them. In various embodiments, the processor(s) 1102 may include one or more central processing units (CPUs), graphics processing units (GPUs), field programmable gate arrays (FPGAs), systems on chip (SoC), or other processor(s) or combinations of processors.

The computing device 1100 includes memory 1104, which is coupled to the processor(s) 1102. The memory 1104 may be used for storing data, metadata, and programs for execution by the processor(s). The memory 1104 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 1104 may be internal or distributed memory.

The computing device 1100 can further include one or more communication interfaces 1106. A communication interface 1106 can include hardware, software, or both. The communication interface 1106 can provide one or more interfaces for communication (such as, for example, packet-based communication) between the computing device and one or more other computing devices 1100 or one or more networks. As an example, and not by way of limitation, communication interface 1106 may include a network interface controller (NIC) or network adapter for communicating with an Ethernet or other wire-based network or a wireless NIC (WNIC) or wireless adapter for communicating with a wireless network, such as a WI-FI. The computing device 1100 can further include a bus 1112. The bus 1112 can comprise hardware, software, or both that couples components of computing device 1100 to each other.

The computing device 1100 includes a storage device 1108 includes storage for storing data or instructions. As an example, and not by way of limitation, storage device 1108 can comprise a non-transitory storage medium described above. The storage device 1108 may include a hard disk drive (HDD), flash memory, a Universal Serial Bus (USB) drive or a combination these or other storage devices. The computing device 1100 also includes one or more I/O devices/interfaces 1110, which are provided to allow a user to provide input to (such as user strokes), receive output from, and otherwise transfer data to and from the computing device 1100. These I/O devices/interfaces 1110 may include a mouse, keypad or a keyboard, a touch screen, camera, optical scanner, network interface, modem, other known I/O devices or a combination of such I/O devices/interfaces 1110. The touch screen may be activated with a stylus or a finger.

The I/O devices/interfaces 1110 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O devices/interfaces 1110 is configured to provide graphical data to a display for presentation to a user. The graphical data may be representative of one or more graphical user interfaces and/or any other graphical content as may serve a particular implementation.

In the foregoing specification, embodiments have been described with reference to specific exemplary embodiments thereof. Various embodiments are described with reference to details discussed herein, and the accompanying drawings illustrate the various embodiments. The description above and drawings are illustrative of one or more embodiments and are not to be construed as limiting. Numerous specific details are described to provide a thorough understanding of various embodiments.

Embodiments may include other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

In the various embodiments described above, unless specifically noted otherwise, disjunctive language such as the phrase “at least one of A, B, or C,” is intended to be understood to mean either A, B, or C, or any combination thereof (e.g., A, B, and/or C). As such, disjunctive language is not intended to, nor should it be understood to, imply that a given embodiment requires at least one of A, at least one of B, or at least one of C to each be present.

We claim:

1. A computer-implemented method comprising:
receiving an input including an audio sequence;
analyzing the audio sequence to determine filler word candidates;
classifying, by a filler word classification model, each filler word candidate of the filler word candidates into one of a set of categories; and
generating an output audio sequence, the output audio sequence including an identification of a subset of the filler word candidates in a filler words category of the set of categories as identified filler words.

2. The computer-implemented method of claim 1, wherein analyzing the audio sequence to determine the filler word candidates comprises:
detecting, by a trained voice activity detection model, locations of voice activity in the audio sequence.
generating, by a speech recognition model, a transcription of the audio sequence; and
determining the filler word candidates at detected locations of voice activity without corresponding transcript data in a transcription of the audio sequence.

3. The computer-implemented method of claim 2, wherein determining the filler word candidates at the detected locations of voice activity without corresponding transcript data in the transcription of the audio sequence further comprises:
determining a start timecode and end timecode for each filler word candidate of the filler word candidates.

4. The computer-implemented method of claim 1, wherein generating the output audio sequence further comprises:
receiving modifications to the output audio sequence at locations of the identified filler words; and
generating a modified output audio sequence, the modified output audio sequence including the modifications applied to the output audio sequence at the locations of the identified filler words.

5. The computer implemented method of claim 4, wherein the modifications include one or more of: automatically deleting portions of the output audio sequence at the locations of identified filler words, muting the output audio sequence at the locations of the identified filler words, and substituting audio at the locations of the identified filler words.

6. The computer-implemented method of claim 1, wherein the set of categories include filler words, regular words, laughter, music, and breath.

7. The computer-implemented method of claim 1, wherein classifying the filler word candidate into one of a set of categories comprises:
for each filler word candidate, assigning a category label to the filler word candidate.

8. The computer-implemented method of claim 1, further comprising:
rendering a representation of the output audio sequence in a user interface, wherein the identification of a subset of the filler word candidates is represented visually associated with representation of the output audio sequence.

9. A non-transitory computer-readable storage medium storing executable instructions, which when executed by a processing device, cause the processing device to perform operations comprising:
receiving an input including an audio sequence;
analyzing the audio sequence to determine filler word candidates;
classifying, by a filler word classification model, each filler word candidate of the filler word candidates into one of a set of categories; and
generating an output audio sequence, the output audio sequence including an identification of a subset of the filler word candidates in a filler words category of the set of categories as identified filler words.

10. The non-transitory computer-readable storage medium of claim 9, wherein to analyze the audio sequence to determine the filler word candidates the instructions further cause the processing device to perform operations comprising:
detecting, by a trained voice activity detection model, locations of voice activity in the audio sequence.
generating, by a speech recognition model, a transcription of the audio sequence; and
determining the filler word candidates at detected locations of voice activity without corresponding transcript data in a transcription of the audio sequence.

11. The non-transitory computer-readable storage medium of claim 10, wherein to determine the filler word candidates at the detected locations of voice activity without corresponding transcript data in the transcription of the audio sequence the instructions further cause the processing device to perform operations comprising:
determining a start timecode and end timecode for each filler word candidate of the filler word candidates.

12. The non-transitory computer-readable storage medium of claim 9, wherein to generate the output audio sequence the instructions further cause the processing device to perform operations comprising:
receiving modifications to the output audio sequence at locations of the identified filler words; and
generating a modified output audio sequence, the modified output audio sequence including the modifications applied to the output audio sequence at the locations of the identified filler words.

13. The non-transitory computer-readable storage medium of claim 12, wherein the modifications include one or more of: automatically deleting portions of the output audio sequence at the locations of identified filler words, muting the output audio sequence at the locations of the identified filler words, and substituting audio at the locations of the identified filler words.

14. The non-transitory computer-readable storage medium of claim 9, wherein the set of categories include filler words, regular words, laughter, music, and breath.

15. The non-transitory computer-readable storage medium of claim 9, wherein to classify the filler word candidate into one of a set of categories the instructions further cause the processing device to perform operations comprising:
for each filler word candidate, assigning a category label to the filler word candidate.

16. The non-transitory computer-readable storage medium of claim 9, wherein the instructions further cause the processing device to perform operations comprising:
rendering a representation of the output audio sequence in a user interface, wherein the identification of a subset of the filler word candidates is represented visually associated with representation of the output audio sequence.

17. A system comprising:
a memory component; and
a processing device coupled to the memory component, the processing device to perform operations comprising:
receiving an input including an audio sequence;
detecting, by a trained voice activity detection model, locations of voice activity in the audio sequence;
classifying, by a filler word classification model, voice activity within the detected locations of voice activity into one of a set of categories; and
generating an output audio sequence, the output audio sequence including an identification of a subset of the voice activity as identified filler words.

18. The system of claim 17, wherein to classify the voice activity within the detected locations of voice activity into one of the set of categories the processing device further performs operations comprising:
sliding the filler word classification model across the audio sequence in predetermined time segments;
for each time segment, predicting a probability value, the probability value indicating a likelihood of the time segment including a filler word; and
identifying locations of the identified filler words based on the probability values for each time segment and a threshold value.

19. The system of claim 18, wherein the processing device further performs operations comprising:
determining a start timecode and end timecode for each of the identified locations of the identified filler words.

20. The system of claim 17, wherein to generate the output audio sequence the processing device further performs operations comprising:
receiving modifications to the output audio sequence at locations of the identified filler words, wherein the modifications include one or more of: automatically deleting portions of the output audio sequence at the locations of identified filler words, muting the output audio sequence at the locations of the identified filler words, and substituting audio at the locations of the identified filler words; and
generating a modified output audio sequence, the modified output audio sequence including the modifications applied to the output audio sequence at the locations of the identified filler words.
